(19) United States
(12) Patent Application Publication
(10) Pub. No.: US 2024/0310689 A1
(43) Pub. Date: Sep. 19, 2024

(54) FAST ACTIVE BEAM-STEERING DEVICE AND APPARATUS OPERATING IN TRANSMISSION MODE

(71) Applicants: CENTRE NATIONAL DE LA RECHERCHE SCIENTIFIQUE, PARIS (FR); UNIVERSITE CÔTE D'AZUR, NICE Cedex (FR)

(72) Inventors: Christina KYROU, ANTIBES (FR); Patrice GENEVET, GRASSE (FR); Samira KHADIR, ANTIBES (FR); Renato Juliano MARTINS, ANTIBES (FR)

(73) Assignees: CENTRE NATIONAL DE LA RECHERCHE SCIENTIFIQUE, PARIS (FR); UNIVERSITE CÔTE D'AZUR, NICE Cedex (FR)

(21) Appl. No.: 18/576,906

(22) PCT Filed: Jul. 6, 2022
(86) PCT No.: PCT/EP2022/068685

§ 371 Date: Jan. 5, 2024

(30) Foreign Application Priority Data
Jul. 9, 2021 (EP) 21305949.6

(51) Int. Cl. G02F 1/29; G02F 1/133

(52) U.S. Cl. CPC G02F 1/29; G02F 1/133; G02F 2203/24

(57) ABSTRACT

A beam-steering device (BSD) including a dielectric substrate (DS) and a cover window (DCW), both transparent; a plurality of transparent conducting rails (VEL), extending parallel to each other between the dielectric surfaces, dividing a space between the substrates into a plurality of elongated cells (LC₀-LC₃); a nematic liquid crystal (LC) filling the elongated cells; and a plurality of electrical interconnections (ELI) suitable to apply an electric potential (V₀-V_{N}) to each one of the conducting rails. The pitch P of the conducting rails is smaller than an optical wavelength λ; and the height H of the conducting rails is at least equal to λ/Δn, Δn being the birefringence of the liquid crystal at the optical wavelength.

### FIELD

The invention relates to a beam-steering apparatus operating in transmission mode at high speed (in the range between 100 kHz and several MHz). It applies in particular, but not exclusively, to the field of LiDAR (Light Detection and Ranging).

### SUMMARY

Imaging systems based on the LiDAR (Light Detection and Ranging) technology enable the dynamic sensing of the ranging distance of fast-moving objects and can be considered as the key technology for the autonomous vehicles. LiDARs usually employ beam steering devices which enable to send a beam of light to any arbitrary direction to spatially scan a large angular field-of-view (FoV) with high speed and strong efficiency. Current beam steering devices operating either in reflection or in transmission mode, encompass among others mechanical laser scanners, integrated Optical Phased Arrays (OPAs), Micro-electro-mechanical systems (MEMS) deflectors, Acousto-optic (AO) and Liquid Crystal (LC) modulators. Each of these technologies has its own advantages and limitations. For instance:
Mechanical laser scanners have a large FoV, but the use of mechanically moving parts make them slow, bulky, complex and vulnerable to mechanical failures.
integrated OPAs, based on waveguide arrays, offer high scanning frequencies (of the order of MHz) and moderate FoVs (within 20 to 50 deg), but they are complex and limited to low output optical powers due to insertion loss.
AO deflectors also offer high modulation frequencies, of the order of MHz, but are limited to small deflection angles (usually <2deg) and limited efficiency of around 70%.
MEMS modulators have acceptable FoV (within 20-60deg.) but are quite slow for LiDAR applications (scanning frequencies in the kHz range) and only operate in reflection mode, which provides less flexibility in terms of device integration.

Phase or amplitude LC modulators are particularly promising as they can operate in transmission mode. Moreover, these are lightweight, they operate with low control voltages (a few volts) and they can be integrated on-chip. However, commercially available LC modulators have limited potentiality for LiDAR applications because of their slow scanning frequencies in the range of kHz regime, as well as the not entirely satisfactory optical efficiency for large deflection angles due to high-order diffraction effects and relatively low FoV. [Kim 20] describes a state-of-the art LC beam-steering device operating in transmission mode.

Current light deflectors based on nematic LCs (or NLCs) exploit the ability of these materials to adapt their optical properties to external stimuli including temperature, electromagnetic fields, and mechanical stresses. Particularly, the application of an electrical voltage can induce a controllable phase retardation to the transmitted beam, required to deflect the light from its initial direction. NLCs consist of positionally disordered elongated molecules which are statistically oriented along a common macroscopic axis of symmetry (i.e. the N-director). NLCs exhibit physical properties dependent on the orientation but remain highly viscous as the ordinary liquids. When a NLC of positive (negative) dielectric anisotropy is confined between two electrodes, a voltage application causes bulk elastic deformations leading to collective rotations of the LC molecules along (perpendicularly) to the electric field direction. A uniform NLC reorientation requires a perfectly aligned LC prior to the voltage application. The latter is achieved when the LC is placed at the vicinity of a solid surface which is mechanically or (photo-)chemically treated to control its orientation at the interface via the so called “anchoring effect”. The LC reorientation occurs to minimize the LC free energy resulting from the competition between the electrical and the anchoring forces. LC molecules exhibit uniaxial birefringence in the range 0.05-0.45, with an optical axis aligned with the longitudinal axis of the molecules.

As illustrated on FIG. 1, conventional LC modulators use micrometric NLC layers (reference LC modulator) confined between planar transparent electrodes. The bottom electrode, supported by a dielectric bottom substrate BS, is usually pixelated with a micrometric pitch (pixels PV₀, PV₁, PV₂, PV₃, aligned along a “x” direction), while the top electrode RV0 is kept at a reference voltage V₀. A protective glass PG may also be present above the top electrode. On the example of FIG. 1, pixel PV₀ is kept at voltage V₀, therefore no electric field acts on the LC molecules, which remains aligned in the “x” direction parallel to the planar electrodes due to the existence of alignment layers that induce an initial (no-voltage) alignment along the x-direction; pixels PV₁, PV₂ and PV₃ are kept at increasing voltages V₁, V₂, V₃, resulting in electric fields of increasing intensity which induce a gradual rotation of the LC molecules as a function of the pixel. For high voltage, like in pixel PV₃, the LCs of positive dielectric anisotropy are aligned along the “z” direction, perpendicular to the planar electrode. A beam of light LB propagating along the “z” direction and polarized along the “x” direction which impinges on the bottom electrode experiences a refraction index which decreases stepwise from nₑ (extraordinary index) in PV₀ to nₒ (ordinary index) in PV₃, resulting in deflection of the beam.

By considering a NLC compound of optimal dielectric and visco-elastic properties for fast field-induced reorientation, the response time τ of the LC modulator to an electric field is mainly dictated by the thickness (H) of the LC layer confined between the two electrodes. To address 2π phase shift necessary for full wavefront manipulation, the LC thickness H cannot be smaller than λ/Δn, with Δn=nₑ−nₒ being the LC birefringence. As a result, for those conventional NCL, τ is of the order of few milliseconds. Moreover, for LC-modulators operating in the visible range, the separation of the pixelated electrodes by a spacing much larger the incident wavelength leads not only to weak deflection angles but also to higher diffraction orders that negatively affect the device efficiency. Fringe effects at the boundaries of adjacent pixels further increases the amount of light directed to higher diffraction orders.

Metasurface-based transmissive light deflectors create a gradient of refractive index by employing high refractive index dielectric optical elements of subwavelength size and spacing whose lateral dimensions are gradually varying along one direction but their thickness is large enough (˜1 μm), as required to support propagative modes. The latter leads to a generalized law of refraction and any deflection angle can be achieved by properly adjusting the phase discretization levels provided by each metasurface repeated unit [Yu11]. The subwavelength topography of metasurfaces suppresses the higher diffracted orders offering high deflection efficiencies and large deflection angles (above 60deg.). The main limitation of metasurface-based deflectors is that they are designed and fabricated once and for all to deflect along a pre-decided and fixed angle, serving essentially as passive optical elements. It has been proposed to make tunable metasurfaces by using them in conjunction with LC. For instance, US 2020/0303827 discloses a light deflector operating in reflecting mode based on a metasurface formed by conducting rectilinear nano-antennas of sub-wavelength width and spacing. A LC fills the spaces between nano-antennas. A voltage applied between adjacent nano-antenna controls the orientation of the LC molecules, and therefore the electromagnetic environment of the nano-antennas. It has been demonstrated that this allows controlling the deflection angle. A drawback of this approach is that it only allows reflection-mode operation, which is sometimes unpractical in terms of integration and limits the maximum achievable optical efficiency.

[Li19] describes another architecture for a tunable metasurface, comprising dielectric nanopillars surrounded by a liquid crystal whose orientation is controlled by a voltage applied between a top and a bottom electrode. This architecture allows beam-steering in transmission mode, but its performances are not entirely satisfactory: the FoV does not exceed ±11°, optical efficiency is of the order of 35% and the scanning frequency is only slightly larger than for a conventional LC modulator.

### SUMMARY

The invention aims at overcoming, in full or in part, these drawbacks of the prior art. More particularly it aims at providing an integrated beam-steering apparatus operating in transmission mode at high speed, with high optical efficiency and achieving a wide FoV (several degrees, or tens of degrees).

According to the invention, these aims are achieved by positioning elongated transparent electrodes at subwavelength distances, one with respect to its neighbor. It results in an ensemble of subwavelength gaps, or “grooves”, that are infiltrated with NLC and that can be individually actuated by applying a potential difference to induce NLC reorientation within the gap. This approach has several advantages: the resulting subwavelength topography of the metasurface leads to the NLC subwavelength nanostructuration suppressing then the higher diffracted orders and thus offering high deflection efficiencies; the vertical electrodes separating the cells avoid fringing effects; the small distance between electrodes reduces the response time of the LC.

It is worth stressing the differences between the present invention and the teaching of US 2020/0303827. In the device of US 2020/0303827, the vertical electrodes act as resonant nano-antennas and the LC constitute their—tunable—dielectric environment, whose interaction with the nano-antennas determines the phase-shift of reflected light. In the invention, the vertical electrodes behave as simple transparent dielectric slabs with respect to optical radiation, which only undergoes a phase shift when it is confined in the LC, by exploiting the working principle of a conventional LC modulator.

### BRIEF DESCRIPTION OF THE FIGURES

Additional features and advantages of the present invention will become apparent from the subsequent description, taken in conjunction with the accompanying drawings, wherein:

FIG. 1, already discussed, illustrates the structure and operation principle of a LC beam-steering device according to the prior art;

FIG. 2 illustrates the reorientation of NLC under the influence of an electric field for vertical initial (voltage OFF) alignment of the LC molecules;

FIG. 3 shows the change in the NLC refractive index experienced from x-polarized light, resulted from a full 90° reorientation;

FIG. 4 illustrates a periodic pattern of 2π phase shifting elements forming a “supercell”, allowing efficient deflection of an incident light beam;

FIG. 5 shows a side view of an isolated 2π supercell providing four (4) phase discretization levels by adjusting the refractive index of the four NLC cells located between successive transparent vertical electrodes to convert the incident beam IB to the deflected beam DB;

FIG. 6 is a schematic representation of the device (top-view) including the device active area comprised of periodically repeated alternating transparent electrodes and LC cells, the printed ohmic contacts and the driving circuit boards.

FIG. 7 A presents a plot showing the difference in the effective refractive index of a single hybrid electrode-NLC pixel before the voltage application and for the maximum voltage-induced reorientation, as a function of the electrode filling factor (ff) per pixel. The gray-scale color maps

FIG. 7 B are the near electric field distributions illustrating the optical mode confinement into the different pixel contributions (i.e. NLC and the high index electrode respectively) for electrode ff 5% and 50% per total pitch P.

FIG. 8 is the phase map obtained by two-dimensional finite-difference time-domain (2D FDTD) simulations for a single hybrid pixel as swiping the NLC rotation angle θ and the transparent electrode width W (GaN has been considered for the simulation but any other transparent and conductive material could be considered). A ˜2π phase shift is obtained when W˜100 nm or lower. The value of W leading to 2π phase shift would be modified using another electrode material.

FIG. 9 is the transmission map obtained by two-dimensional finite-difference time-domain (2D FDTD) simulations for a single hybrid pixel as swiping the NLC rotation angle θ and the transparent electrode width W (GaN has been considered). A transmission close to unity (1) is obtained when W˜100 nm or lower.

FIG. 10 illustrates how the deflection angle depends on the number of phase levels (M) forming a pattern of the type illustrated by FIG. 4;

FIG. 11 illustrates the dependency of the device efficiency on the deflection angle; and

FIG. 12 is a scheme of a bi-dimensional beam-steering apparatus according to an embodiment of the invention.

### DETAILED DESCRIPTION

In the following description “light” designates electromagnetic radiation in the mid-infrared (3 μm-50 μm), near infrared (780 nm-3 μm), visible (380 nm-780 nm) or near ultraviolet (200 nm-380 nm). Similarly, “optical wavelengths” include mid-infrared (3 μm-50 μm), near infrared (780 nm-3 μm), visible (380 nm-780 nm) and near ultraviolet (200 nm-380 nm) wavelengths. Unless specified otherwise, wavelengths are measured in vacuum.

A physical body will be considered “transparent” at a given wavelength if its transmission coefficient at said wavelength is not lower than 0.9.

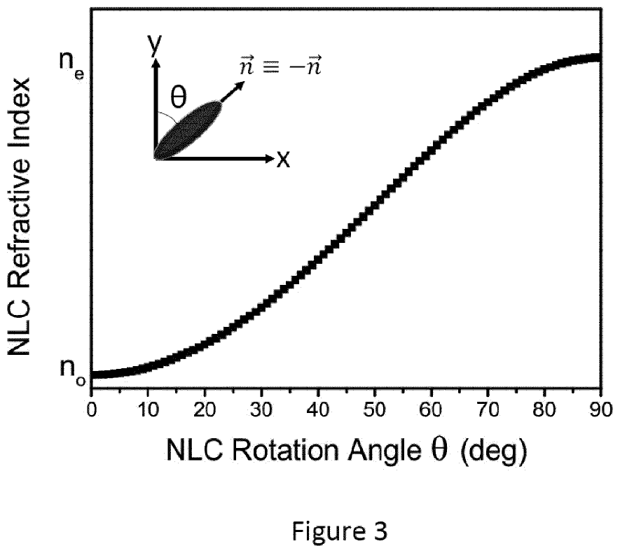

FIG. 2 illustrates the full electrical reorientation of a NLC of positive dielectric anisotropy between two vertical, conductive, and transparent rectangular electrodes EL (side view) forming grooves, described by the configurations LCI and LCF. When no voltage is applied between the electrodes (VOFF), a LC aligned normally to the sub-wavelength grooves designed on a substrate SB is considered (i.e. NLC director along y direction). The application of high electric field (nonzero voltage VON) results in a 90° out-of-plane NLC reorientation along its direction between the voltage-off (VOFF) and the voltage-on (VON). VON state corresponds to the maximum electric applied field. FIG. 3 shows that the NLC refractive index varies smoothly between nₒ and nₑ when the rotation angle of the NLC molecules varies between 0° (LCI configuration) and 90° (LCF configuration).

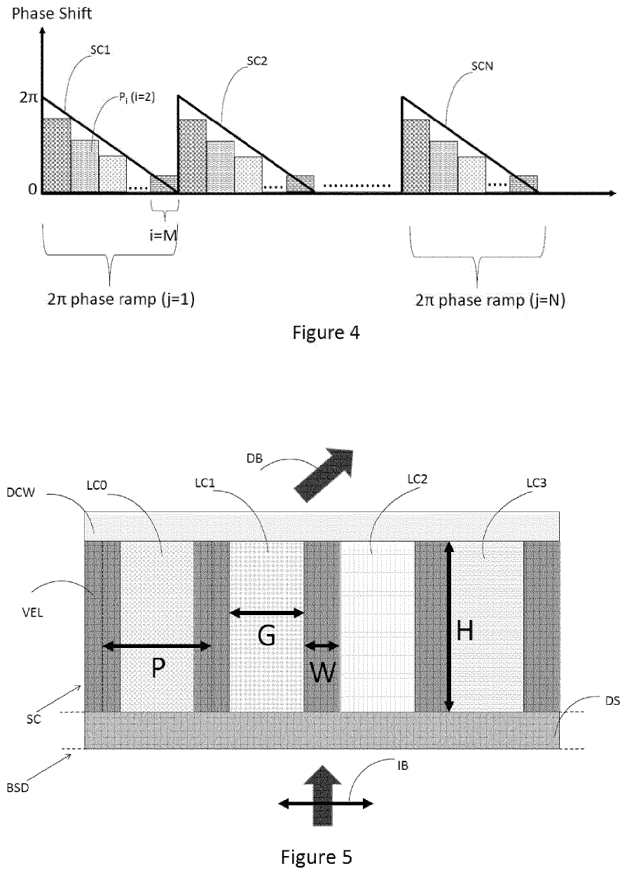

FIG. 5 illustrates a portion SC (called a “supercell” for reason which will be explained later with reference to FIG. 4) of a beam-steering device BSD according to an embodiment of the invention comprises a dielectric substrate DS and a dielectric cover window (DCW), transparent at least at one optical wavelength, λ. For instance, they may be made of sapphire (Al₂O₃). DS and DCW have planar parallel surfaces, facing each other at a distance at minimum equivalent to the thickness H of the transparent vertical electrodes (VEL), that is, in the micrometer range. Hereafter, the x and z directions parallel to the faces of the substrates will be called “horizontal” direction and direction y, perpendicular to the faces of the substrate, and along the electrode thickness H, will be called vertical.

A plurality (five on FIG. 5) of conducting rails—or vertical electrodes VEL extend vertically from the upper surface of lower substrate DS to the lower surface of upper DCW. Said conducting rails also extend—preferably rectilinearly—in the z (or “longitudinal”) direction, thus subdividing the space between the two substrates into a one-dimensional array of elongated cells (or one-dimensional pixels) arranged along the x direction, which are filled with a nematic liquid crystal denoted as LC0-LC3. The conducting rails are transparent at least at said optical wavelength λ; for instance, they may be made of highly Si doped (˜10²⁰ cm⁻³) GaN epitaxially grown on DS. The length of the rails may extend to several hundreds of microns or more.

A whole beam-steering device BSD is typically composed of a plurality of adjacent supercells.

The pitch P of the conducting rails—defined as the width (measured in the x direction) of one cell plus the width W (also measured in the x direction) of one conducting rail—shall be smaller than wavelength λ. For instance, in the visible range P may be between 200 nm and 500 nm while in the near-infrared it may extend at around 2 μm. The array of cells need not be strictly periodic; otherwise stated, its pitch may vary along the x direction.

The aspect ratio H/W of the conducting rails is typically greater than 10, for instance of about 15 depending on the birefringence of the NLC and the wavelength of the incident light.

The dimensioning of device BSD—is particularly defined by the three parameters H, P and W.

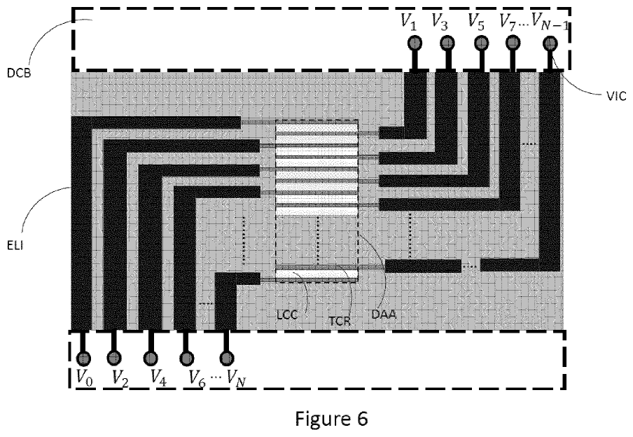

As illustrated in FIG. 6, electrical interconnections ELI can be individually connected from the one side at each transparent conducting rail TCR and from the other side to a respective port of a driving circuit board DCB (e.g. an integrated circuit) which is configured for applying an electric potential V₀, V₁, V_{N-1}, V_{N} to the rail voltage input channel VIC and accordingly re-orient the successive LC cells LCC located in the device active area DAA. The electrical interconnections may be made of any conducting material suitable for ohmic contacts, for instance, copper or gold paths on a printed circuit board contacting the conducting rails at one of their ends. Modern electronics technology makes the realization of such a dense interconnection pattern feasible. For instance, UV-lithography can be employed to design a specific interconnection pattern that fits the active area of the device that may be fabricated by electron-beam lithography (or deep UV lithography or nano-imprinting lithography), followed by electron beam metal evaporation, lift-off process and ICP-RIE (inductive coupled plasma-reactive ion etching) etching. One or more DCB may be considered, according to the exact design of the ELI. The driving circuits may be printed directly on-glass or connect to the device as external panels (out-of-glass). A driving algorithm may be used to regulate the desired voltage pattern provided by the successive electrodes,

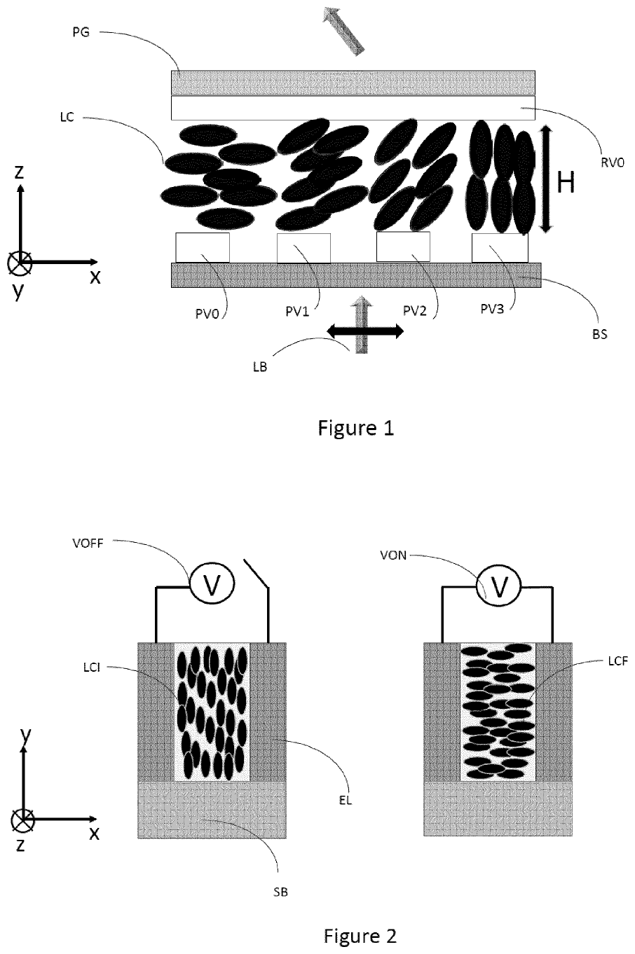

When the two conducting rails confining a single NLC cell are kept at different electric potentials, an electric field which modifies the orientation of the liquid crystal molecules is generated in the cell and the NLC reorientation changes the extraordinary effective refractive index experienced by a light beam IB propagating through the device with a propagation direction exactly or approximately aligned with the y axis and linearly polarized in the x direction. However, the ordinary refractive index is not affected by the reorientation. This configuration has several advantages compared to the conventional one illustrated on FIG. 1:
Considering a particular NLC compound and for a given potential difference and anchoring strength, the LC switching time is proportional to G²=(P−W)², which is much smaller than H², resulting in faster operation—typically be one or two orders of magnitude, leading to approximately 100 kHz 1 MHz LC reorientation frequency.
Adjacent cells are separated by hard wall, avoiding loss-inducing fringing effects.
The subwavelength geometry of the cells in the x direction suppresses the higher diffracted orders offering high deflection efficiencies. Indeed, the inventive device can be considered an electrically tunable metasurface.
For visible optical wavelengths, the nanoscale confinement of the LC molecule ensures their high-quality, homogeneous alignment before the application of an electric field. An associated drawback is that the same nanoscale confinement induces strong anchoring forces which requires large electric fields to be overcome, but the lower the pitch, the larger the electric field for a given potential difference. Depending on the geometric parameters of the transparent and conductive metasurface, the physical properties (dielectric, visco-elastic) of the LC and the strength of interfacial interactions between the LC and the underlying metasurface, a voltage value in the range of 1-10 V is adequate for the LC activation.

For the “electric field—off state” the liquid crystal molecules may be oriented along the y direction. This initial (VOFF) alignment condition, normal to the grooves plane, may be achieved by controlling the interfacial interactions between the LC molecules and the transparent electrodes as well as the geometrical parameters of the conducting and transparent metasurface (for instance the aspect ratio of the electrodes). An alignment layer may cover the DS and DCW upper and lower surface respectively to force the vertical or other alignment. The latter can be realized by employing conventional alignment techniques such as photoalignment and/or chemical alignment. By gradually increasing the voltage difference between two neighboring conducting rails, and therefore the strength of the electric field in the x direction, a controllable out-of-plane (i.e. in the yx plane) reorientation of the LC optic axis be may induced by considering a NLC of positive dielectric anisotropy. This causes a progressive change of the refractive index n_{LC} experienced by light propagating in the y-direction and polarized in the x-direction. More precisely, the refraction index n_{LC} progressively increases from n₀ (ordinary index) to nₑ (extraordinary index):

$${n}_{LC} ( θ ) = \frac{{n}_{o} {n}_{e}}{\sqrt{{n}_{e}^{2} {cos}^{2} θ + {n}_{o}^{2} {sin}^{2} θ}}$$

where θ is the angle formed by the optical axis of the LC molecules and the wave-vector of the incident light, which in turn is an increasing function of the absolute value of the electric field strength in the x direction. It can easily be seen that n_{LC}(0°)=nₒ and n_{LC}(90°)=nₑ.

FIG. 3 is a plot of the change of the LC (with positive dielectric anisotropy) refractive index experienced by x-polarized light, as a function of the LC out-of-plane rotation angle induced by the external electrical voltage (i.e. the potential difference) between the two conducting rails delimitating a cell of the beam-steering device. Depending on the anchoring condition at the NLC-electrode interface prior to the voltage application and the sign of the dielectric anisotropy of the NLC, different in-plane or out-of-plane reorientation configurations may be considered. For instance, if the initial alignment is along the z-direction, a LC of negative dielectric anisotropy may be chosen as a tunable material. Another example is to consider in-plane reorientation of molecules of positive dielectric anisotropy aligned along the grooves axes (i.e. along z-direction) prior to the voltage application. The initial (VOFF) alignment condition, the NLC reorientation mechanism and the sign of the NLC dielectric anisotropy must be accounted accordingly for phase-only and/or amplitude modulation. Generally, NLCs of negative dielectric anisotropy are not highly preferred options for phase-only modulation due to their low dielectric anisotropy values compared to the NLC molecules with positive dielectric anisotropy. Low dielectric anisotropy will increase the LC response time to an applied electrical voltage.

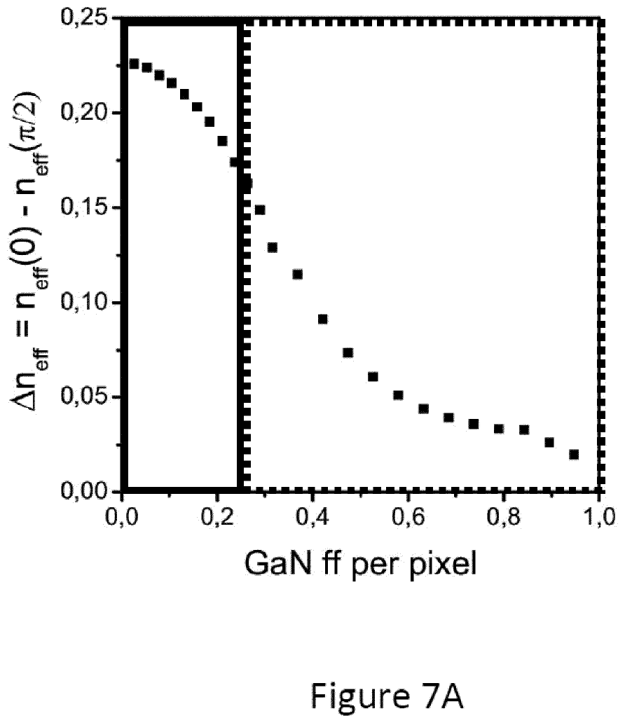

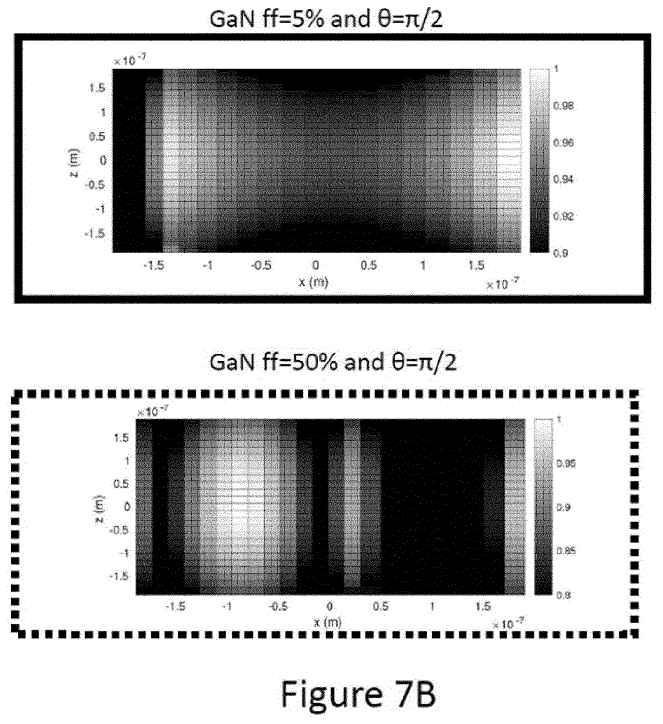

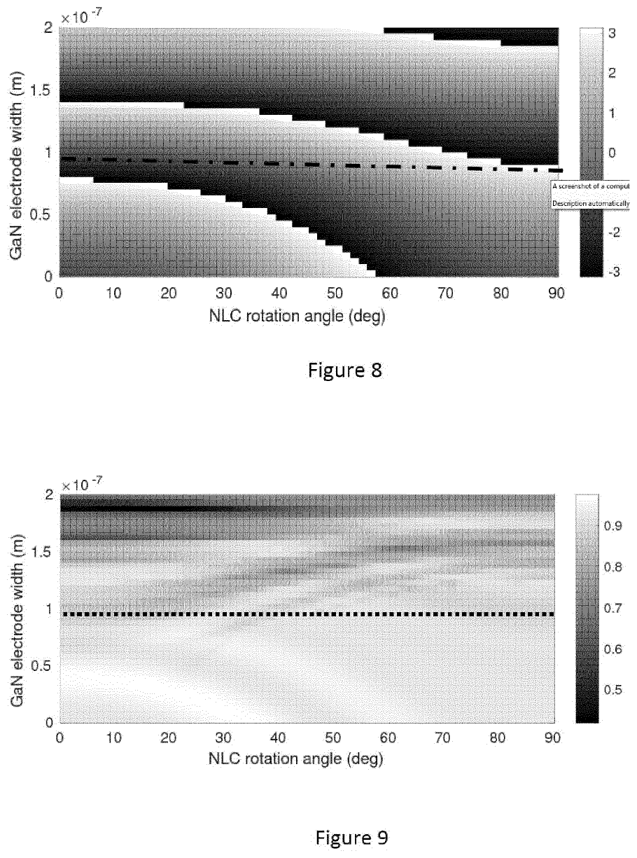

If the conducting rails had a negligible width (W→0), then the minimum thickness H of the cells would be given by λ/Δn, with Δn=nₑ−n₀˜0.2-0.4 for most common LC, to allow a full 2π phase retardation. In fact, usually W is not negligible due to the limitations induced by the conventional nanofabrication methods including for instance electron-beam and nanoimprinting lithography. Thus the effective index n_{eff} of then hybrid metasurface forming the device can be considered as a weighted average of n_{LC}(θ) and of the refraction index of the conducting rails, which is independent from the applied potentials. As a consequence the maximum achievable variation of the effective index Δn_{eff} is smaller than Δn. This observation is critical to the invention, as it is not evident, a priory, to avoid electromagnetic confinement in the transparent electrodes. Electromagnetic simulations allow computing the dependence of Δn_{eff} with respect to the rail filling factor of the cell W/P. FIGS. 7 and 8 show the results of such a computation for a nematic LC with Δn=0.23 (nₒ=1.51 and nₑ=1.74 at 650 nm) and GaN (n_{GAN}=2.38 at 650 nm) conducting rails grown on a sapphire substrate, λ=650 nm and P=380 nm. It can be seen that for a GaN filling factor of 25% (i.e. W=95 nm) or smaller the LC pixel contribution enables beam steering,

Note that confined electromagnetic modes can only exist if the pitch of the structure is not too small compared to the wavelength. Ideally, P should be of the order of half the operating wavelength in the material, with a tolerance X, usually not exceeding ±0.4λ (i.e. 40%), preferably ±0.2 (20%) and even more preferably ±0.1 (10%), to account for both the fabrication feasibility of the lateral dimension of the solid metasurface and the LC anchoring strength control at its interfaces with the metasurface. The latter should be carefully considered if the device operates within the visible wavelength range.

It can be seen in FIG. 7 that Δn_{eff} does not depend linearly on the GaN filling factor ff. Indeed, the modal distribution of electromagnetic radiation in the device must be considered. As seen in FIGS. 7A and 7B, for small GaN filling factors (5% in the example of FIG. 7A) the electric field modes are mainly confined in the LC and Δn_{eff}=Δn; for large GaN filling factors (50% in the example of FIG. 7B) the modes are mostly confined in the conducting rails and Δn_{eff}<<Δn. The latter situation should be avoided to achieve 2π phase retardation as it would require fabricating structures with extremely challenging aspect ratio. A threshold value for the filling factor can be defined at approximately 25%. The latter value may change by considering different degrees of refractive index contrast between the LC and the underlying transparent and conductive structure.

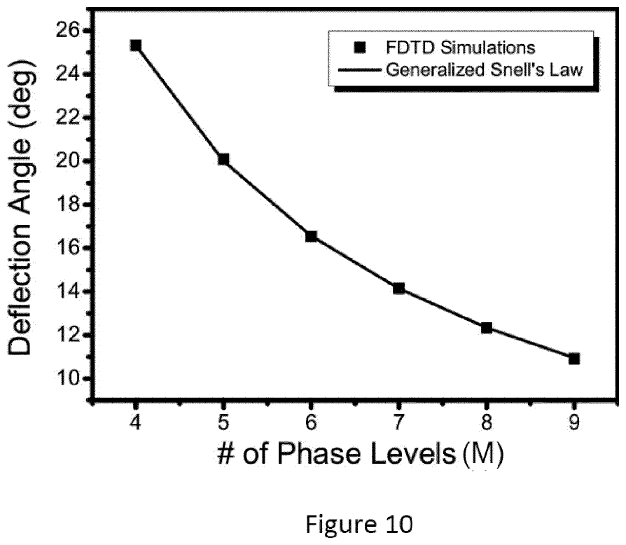

As illustrated on FIG. 4, an optical phase shift equal to 2π may be introduced by phase gradient supercells SC1, SC2, SCN designated by an integer index j which increases in the x direction. Each supercell has the structure illustrated on FIG. 5 and comprises M pixels (M=4 in the present example) designated by an integer index i also increasing in the x direction. The i^{th} pixel Pᵢ of a generic supercell j introduces a phase shift Δϕᵢ=(2πi/M)=idϕ_{M} where dϕ_{M}=2π/M, resulting in a discretized phase ramp from 0 to 2π over a distance P·M, P being the pitch of one hybrid pixel. The repetition of identical supercells results in a periodic “sawtooth” pattern of period P·M. As shown on FIG. 10, the maximum efficient deflection of the normally incident light beam is achieved with M=4 phase level, and decreases for increasing values of M. The angular resolution—i.e. the minimum nonzero deflection—of a device comprising M individually-addressable and periodically repeated pixels is θmin=sin⁻¹(λ/MP). The maximum deflection angle is given by θmax=sin⁻¹(λ/4P). For cells having a 380 nm pitch and operating at λ=650 nm, θmax=±25°, resulting in a FoV of about 50°. As it can be deduced from FIG. 7A a GaN ff of 25% corresponds to a Δn_{eff}˜0.17 and thus lower than the considered NLC birefringence Δn·0.23, in such a case the deflecting operation of the device for a height H˜λ/Δn can be ensured by considering at least four (4) phase discretization levels. For fabrication convenience, the phase discretization allows reduced cell thickness H to H˜λ(2π−dφᵢ)/2πΔn_{eff}.

On FIG. 10, the black squares correspond to the results of 2D FDTD simulation of a 45.6 μm long device along x-direction and a normally incident plane wave polarized along the device periodicity direction. The continuous line corresponds to a theoretical calculation performed using the “generalized Snell law” of [Yu 11]. The very good agreement between the results confirms that the inventive device actually behaves as a NLC metasurface.

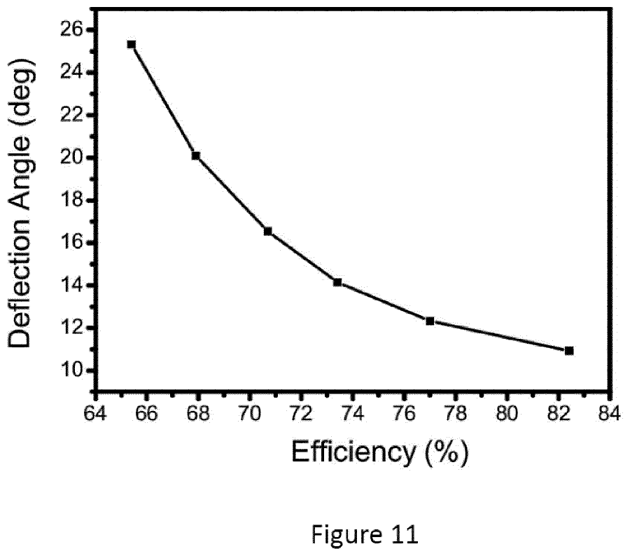

FIG. 11 shows that the optical efficiency (computed using the 2D FDTD method) reaches 85% and decreases for increasing deflection angles but even at θmax=±25° retains a rather satisfactory value of ˜65%, in general around three times larger than the efficiency achieved by devices operating in the reflection mode. An optimization algorithm that enables the local voltage adjustment to improve the efficiency provided for the highest deflection angles may be incorporated to the driving algorithm of the deflector. The latter may be also used to compensate for the design imperfections resulted from the employed fabrication processes.

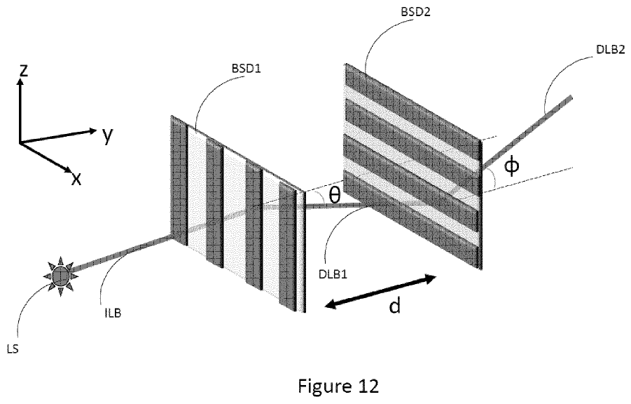

Due to their ability to operate in transmission mode and their high efficiency (FIGS. 9 and 11), two beam-steering devices according to the invention whose conducting rails have non-parallel (and preferably perpendicular) directions can be associated to achieve two-dimensional beam-steering. FIG. 12 shows an optical system comprising a light source LS (for instance, a semiconductor laser provided with collimating optics) generating an incident light beam ILB propagating along a direction y which polarized along x direction and directed to a two-dimensional beam-steering apparatus BSA. The two-dimensional beam-steering apparatus BSA comprises a first beam-steering device BSD1 whose conducting rails are aligned in the z direction, to deflect beam ILB by an angle θ in the xy plane, and a second beam-steering device BSD2, separated from BSD1 by a distance d along the y direction, whose conducting rails are aligned in the x direction, to deflect beam DLB1 by an angle ϕ to DLB2 in the yz far-field plane. The design of the cascaded bi-dimensional beam steering system is non-trivial because of the polarization dependent response of the LC with respect to their specific anchoring configuration. The user has to make technological choices—for instance, using LC with positive or negative anisotropy, choosing the LC reorientation mechanism,—determining the initial anchoring direction at zero volt and the relative groove orientation of BSD1 and BSD2 and selecting the incident polarization in order to achieve a predetermined deflection in two-dimensions.

Often, the designer will seek to avoid birefringent splitting of the light beam. This can be obtained by choosing the input polarization and incident angles of light impinging on each modulator in order to maximize the deflection efficiency at the each modulator. More particularly, in this case, the incident polarization on BSD1 has to be chosen to maximize the refractive index variation upon LC reorientation. Let us consider, for instance, a first modulator BSD1 comprising an electrically tunable out-of-plane LC reorientation with the NLC molecules anchoring normally to the grooves plane at the voltage-off state and having positive dielectric anisotropy. In this case the incident polarization must be perpendicular to the groove axis. The design of BSD1 and incident polarization inform on the design and LC type to be selected for BSD2. Since the extraordinary refractive index is sensitive to the voltage application, the incident light to BSD2 needs be polarized in the same plane as the NLC optic axis in BSD2. Let us consider for instance that grooves of BSD2 are at 90° with respect to those BSD1, implying an initial NLC orientation said normal or parallel to their axes. By considering that the incident polarization on BSD2 is the one that maximizes deflection after BSD1 as previously described, the reorientation mechanism in BSD2 has to be chosen so as to maximize the defection efficiency after BSD2. For example, if out-of-plane reorientation takes place at BSD2, the non-normally incident light impinging on it must have one polarization projection that will be experienced by the NLC at the direction where the phase modulation occurs during the electrical reorientation. In such a case, a NLC of negative dielectric anisotropy is required. The voltage pattern applied to BSD2 has to be scaled accordingly depending on the targeted deflection angle and efficiency.

Different other design strategies may be considered, for example to keep only 1D deflection from either BSD1 or BSD2, or to modulate the transmission efficiency, or to split incident light into several transmitted and deflected output channels. The latter case can easily be implemented by considering rotated polarization or by relative rotation of BSD1 and BSD2 according the specific LC type, anchoring conditions and reorientation mechanism.

The invention has been described with reference to a particular embodiment, but several variants are possible. For instance, different individual LC compounds or mixtures of several compounds of any molecular structure that exhibit one or more LC phases with temperature change (Nematic, Smectic etc) and possess different physical properties such as different values of elastic constants, rotational viscosity, dielectric anisotropy, birefringence etc. may be considered as tunable materials. The LC may be infiltrated into the device by a capillary action in its isotropic liquid phase or under vacuum infiltration. Moreover, the invention may be implemented for phase only and/or amplitude modulation. For the latter case, the device must be placed between a polarizer and an analyzer. For the solid metasurface, any optically transparent and conductive material may be used, an example is the highly doped n-doped GaN but doped polymers, or transparent conductive oxides such as, but not limited to, ITO, for instance, may also be employed. Different materials than those specifically mentioned can be used for the dielectric substrates. Similarly, dimensions for H, P and W and an operating wavelength have been provided as non-limiting examples only. Moreover, the device may operate at environmental or other temperatures.

In some applications, electric substrates DS, DCW need not to be planar; for instance, DS may have a convex upper surface and DCW a concave lower surface, delimitating a curved, shell-like space. Conducting rails need not being perfectly rectilinear and equally spaced but need to ensure the high quality of LC alignment prior to the voltage application. To do so, specific (photo-)chemical or mechanical treatment may be considered to the associated materials to control the alignment properties of the NLC at the interfaces.

### LIST OF REFERENCE SIGNS

PG: Protective glass RV0: Reference electrode corresponding to a voltage input V0
LC: Liquid crystal
BS: Bottom substrate
PV0: Pixelated electrode corresponding to a voltage input V0
PV1: Pixelated electrode corresponding to a voltage input V1
PV2: Pixelated electrode corresponding to a voltage input V2
PV3: Pixelated electrode corresponding to a voltage input V3
LB: Light beam
VOFF: Voltage off
VON: Voltage on corresponding to maximum voltage value
EL: Electrode
SB: Substrate
LCI: LC initial state (voltage off)
LCF: LC final state (maximum voltage on)
VEL: Vertical electrode
DCW: Dielectric cover window
DS: Dielectric substrate
IB: Incident beam
DB: Deflected beam
LC0: Liquid crystal cell where the polarized light impinging on it experiences the ordinary refractive index nₒ
LC1: Liquid crystal cell corresponding where the polarized light impinging on it experiences an refractive index n_{eff}¹ where, nₒ<n_{eff}¹<nₑ
LC2: Liquid crystal cell where the polarized light impinging on it experiences an refractive index n_{eff}² where, nₒ<n_{eff}¹<n_{eff}²<nₑ
LC3: Liquid crystal cell where the polarized light impinging on it experiences the extraordinary refractive index nₑ
DCB: Driving circuit board
VIC: Voltage input channels
DAA: Device active area
LCC: Liquid crystal cell
TCR: Transparent conducting rail
ELI: Electrical inter-connections
LS: Light source
ILB: Incident light beam
DLB1: Deflected light beam in xy plane
DLB2: Deflected light beam in yz plane
H: Height (or thickness)
W: Width
P: Pitch (or period)
G: Gap or width of liquid crystal cells
d: Distance
SC, SC1, SC2, SCN: Supercells

### REFERENCES

[Kim 20] Y. Kim et al. “Large-area liquid crystal beam deflector with wide steering angle” Appl. Opt. 59, 24, 7462-7468 (2020).
[Li19] S-Q Li et al., “Phase-only transmissive spatial light modulator based on tunable dielectric metasurface” Science 364, 6445, 1087-1090 (2019).
[Yu 11] N Yu, & al., Light Propagation with Phase Discontinuities: Generalized Laws of Reflection and Refraction, Science 334 (6054), 333-337 (2011).

1-10. (canceled)

11. An active beam-steering device (BSD) comprising:
a dielectric substrate (DS) and a dielectric cover window (DCW), transparent at one optical wavelength λ, defining a space between them;
a plurality of conducting rails (V₀-V_{N}), transparent at said optical wavelength, extending parallel to each other between said dielectric surfaces, so as to divide said space into a plurality of elongated cells (LCC);
a nematic liquid crystal (LC) filling said elongated cells; and
a plurality of electrical interconnections (ELI) suitable to apply an electric potential (V₀-V_{N}) to each one of said conducting rails;
wherein:
the pitch P of said conducting rails is smaller than said optical wavelength λ; and;
the height H of said conducting rails is at least equal to λ/Δn, Δn being the birefringence of the liquid crystal at said optical wavelength.

12. The beam-steering device of claim 11 wherein the width W of said conducting rails is sufficiently small, compared to their pitch P, to allow confining light at said wavelength λ in the liquid crystal filling said elongated cells.

13. The beam-steering device of claim 11, wherein P=λ/2±λX, where P is the pixel size, λ is the optical wavelength and X is comprised between 0 and 40%.

14. The beam-steering device of claim 11, wherein pitch P is in the sub-micrometer range.

15. The beam-steering device of claim 11, wherein the conducting rails are made of Si-doped GaN.

16. The beam-steering device of claim 11, further comprising an electronic driving circuit board (DCB) configured for applying variable electric potential values to said conducting rails through said electrical interconnections, an electric potential difference between two adjacent conducting rails determining a phase-shift of light at wavelength λ introduced by the cell delimitated by said rails.

17. The beam-steering device of claim 16, wherein said electronic controller is configured for applying to said rails a spatially periodic pattern of electric potentials such that the electric potential difference between two adjacent rails varies monotonically between zero and a maximum value, the maximum value being such that the phase-shift of light at wavelength λ introduced by the corresponding cell is equal to 2π.

18. The beam-steering device of claim 17, wherein said electronic controller is configured for varying a deflection angle of a light beam at wavelength λ by varying the spatial period of said pattern.

19. A bi-dimensional beam-steering apparatus (BSA) comprising a first (BSD1) and a second (BSD2) beam-steering devices according to claim 11, suitable to operate at a same optical wavelength λ, arranged in such a way that a light beam (LB) traversing the first beam-steering device impinges onto the second beam-steering device, the first and second beam-steering devices having conducting rails extending along nonparallel, and preferably perpendicular, directions.

20. An optical system comprising a light source (LS) and either a beam-steering device (BSD) according to claim 11, the light source being configured for directing a light beam (LB) at optical wavelength λ towards said beam-steering device or apparatus.
